(19) United States
(12) Patent Application Publication
(10) Pub. No.: US 2009/0020530 A1
(43) Pub. Date: Jan. 22, 2009

(54) Plastic plug with overcap

(76) Inventor: Gary M. Baughman, Fremont, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/879,252

(22) Filed: Jul. 17, 2007

(51) Int. Cl. B65D 41/04; B23P 11/00; B25B 13/48; B65D 17/50

(52) U.S. Cl. 220/288; 220/233; 29/428; 81/54

(57) ABSTRACT

A closure for a container opening according to one embodiment of the present invention comprises a plug including concave recesses and being constructed and arranged to be received within the container opening and an overcap including inwardly projecting convex forms constructed and arranged for interfit into the recesses of the plug, the overcap being attached to the plug so as to create an assembly, wherein the overcap to plug interfit helps to prevent rotation of the overcap relative to the plug.

### BACKGROUND OF THE INVENTION

The present invention relates in general to plastic plugs that are constructed and arranged to assemble into a container opening, typically by threading. More specifically, the present invention relates to the described style of plastic plug that receives an overcap. Preferably the overcap is constructed and arranged to assemble to the plastic plug and/or container with a tamper-evident configuration and function. In the preferred embodiment the plastic plug is a unitary, molded component and the overcap is a unitary, molded plastic component. These two components are pre-assembled prior to plug insertion into the container opening without any overcap connection to the container. One variation, as disclosed herein, is to replace the plastic overcap with a heat-weld foil disk for covering over the plug.

When designing a closure or closure assembly that preferably includes a tamper-evident configuration or construction, it is important to consider the overall design efficiency, the reliability of the component parts as assembled and as installed, the overall cost, the physical size and the overall aesthetics, to mention some of the relevant considerations. Reliability includes not only how the tamper-evident construction functions in terms of properly revealing when a tampering attempt has been made, but also in not prematurely failing or showing a tampering attempt when none was made.

In one prior art construction, the tamper-evident component is a plastic cover that includes a skirt that cooperates with ratchet projections on an outer surface of the container opening. The size and shape complexity of this tamper-evident component adds to the component cost. The plastic plug threads into the neck opening of the container and then the tamper-evident component is engaged on the container.

In another prior art construction the tamper-evident component is of a part-metal construction in combination with a plastic overcap so that the plastic skirt of the overcap can be crimped around a cooperating form on the outer surface of the container neck opening, after the plastic plug is threaded into the neck opening of the container. This tamper-evident component, similar to the first-described prior art component, is a more costly component that requires a specific style of container due to the structural cooperation between the tamper-evident overcap and the container.

In contrast to these prior art examples, the tamper-evident overcap described herein as one embodiment of the present invention provides a simpler design that engages only the plug providing greater versatility since the container style does not have to be selected to cooperate with a particular style of tamper-evident overcap. While the plastic plug construction that is part of the prior art and depicted by the present invention includes interior structural features or forms for facilitating the threading of the plug into the container neck opening, the present invention does not use those features for the initial assembly of the plug and overcap combination into the container neck opening. Instead, according to one embodiment of the present invention the tamper-evident overcap is preassembled to the plastic plug and the plug features (interior) that might otherwise be used for tightening the plastic plug into the neck opening are covered by the tamper-evident overcap. In another embodiment of the present invention, a heat-weld foil disk is used to close off the interior structural features of the plug. These assembly constructions thus require a different method of installation and different tooling, both of which are described herein and both of which constitute an important part of this overall invention.

The present invention provides a simple and reliable and aesthetically-pleasing, low cost tamper-evident overcap that quickly assembles to the plastic plug. The overcap does not interface with the container neck opening thereby allowing a wider range of container neck styles that remain compatible with the threaded plug. This wider range of container neck opening style also remain compatible with the tamper-evident overcap as disclosed herein.

### BRIEF SUMMARY

A closure for a container opening according to one embodiment of the present invention comprises a plug including overcap-engaging forms and being constructed and arranged to be received within the container opening and an overcap including plug-engaging forms constructed and arranged for interfit with the overcap-engaging forms of the plug, the overcap being attached to the plug so as to create an integral assembly, wherein the overcap to plug interfit helps to prevent rotation of the overcap relative to the plug.

One object of the present disclosure is to provide an improved closure for a container including a plastic plug and overcap.

### BRIEF DESCRIPTION OF THE SEVERAL VIEWS OF THE DRAWINGS

FIG. 1 is a front elevational view, in full section, of a prior art plastic plug.

FIG. 2 is a front elevational view, in full section, of a prior art square-cut gasket that is used with the FIG. 1 plug.

FIG. 3 is front elevational view, in full section, of an internally-threaded container neck opening configured for connection to a tamper-evident cover.

FIG. 4 is a front elevational view, in full section, of a prior art tamper-evident cover constructed and arranged for use with the FIG. 1 plug and the FIG. 3 container neck opening.

FIG. 5 is a front elevational, view, in full section, of the prior art combination of the plug, gasket, cover and container neck opening as illustrated in FIGS. 1-4.

FIG. 6 is a front elevational view, in full section, of an alternative prior art container neck opening.

FIG. 7 is a front elevational view, in full section, of a prior art square-cut gasket.

FIG. 8 is a front elevational view, in full section, of a prior art plastic plug constructed and arranged to be installed into the FIG. 6 container neck opening.

FIG. 9 is a front elevational view, in full section, of a prior art tamper-evident overcap constructed in a range for use with the FIG. 8 plastic plug.

FIG. 10 is a front elevational view, in full section, of the combination of the components and structures illustrated in FIGS. 6-9.

FIG. 11 is a front elevational view, in full section, of a plastic plug according to a typical embodiment of the present invention.

FIG. 12 is a front elevational view of the FIG. 11 plastic plug.

FIG. 13 is a top plan view of the FIG. 12 plastic plug.

FIG. 14 is a front elevational view, in full section, of a tamper-evident overcap according to the present invention.

FIG. 15 top plan view of the FIG. 14 tamper-evident overcap.

FIG. 16 is a front elevational view, in full section, of the FIG. 14 overcap as integrally assembled to the FIG. 12 plastic plug.

FIG. 17 is a front elevational view, in full section, of the FIG. 16 assembly as installed into a container neck opening with a gasket.

FIG. 18 is a front elevational view, in partial section, of a tooling fixture according to a typical embodiment of the present invention.

FIG. 19 is a top plan view of the FIG. 18 tooling fixture.

FIG. 20 is a bottom plan view of the FIG. 18 tooling fixture.

FIG. 21 is a front elevational view, in partial section, of the FIG. 18 tooling fixture in an intermediate position.

FIG. 22 is a front elevational view, in partial section, of the FIG. 18 tooling fixture arranged so as to securely grasp a FIG. 16 assembly.

FIG. 23 is a bottom plan view of the FIG. 22 arrangement.

FIG. 24 is a front elevational view, in partial section, of the FIG. 22 arrangement at the initiation of threaded installation of the FIG. 16 assembly into a container neck opening.

FIG. 25 is a front elevational view, in partial section, of the FIG. 24 arrangement after the FIG. 16 assembly is fully installed.

FIG. 26 is a front elevational view, in full section, of a plastic plug according to one embodiment of the present invention.

FIG. 27 is a front elevational view, in full section, of a tamper-evident overcap according to one embodiment of the present invention.

FIG. 28 is a top plan view of the FIG. 27 tamper-evident overcap.

FIG. 29 is a front elevational view, in full section, of the FIG. 27 overcap, as assembled onto the FIG. 26 plastic plug.

FIG. 30 is a front elevational view, in full section, of a prior art plastic plug.

FIG. 31 is a front elevational view, in full section, of a tamper-evident overcap according to another embodiment of the present invention.

FIG. 32 is a top plan view of the FIG. 31 tamper-evident overcap.

FIG. 33 is a front elevational view, in full section, of the FIG. 31 overcap, as assembled onto the FIG. 30 plastic plug.

### DETAILED DESCRIPTION

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

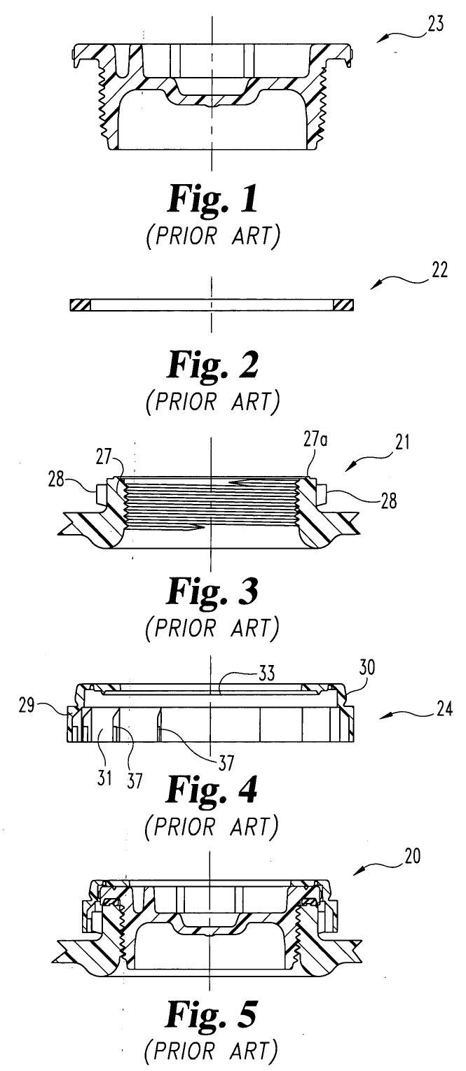

Referring to FIGS. 1-5, a prior art closure system 20 is illustrated. System 20 includes a container opening 21, square-cut gasket 22, plastic plug 23 and tamper-evident cover 24. The assembly of component parts 22-24 into container opening 21 is illustrated in FIG. 5. In this prior art embodiment (system 20) the cylindrical wall 27 that defines internally-threaded opening 21 includes at least one ratchet tab 28, two of which are illustrated in FIG. 3. The tamper-evident cover 24 includes a lower skirt 29 connected to cover body 30. The inside surface 31 of skirt 29 includes a series of ratchet teeth 37 for engagement with tabs 28 so as to prevent removal. The center portion 33 of cover body 30 is constructed and arranged to be removed for access to the top interior portion of plug 23. System 20 represents one style of prior art closure and container design that is being improved upon by the present invention.

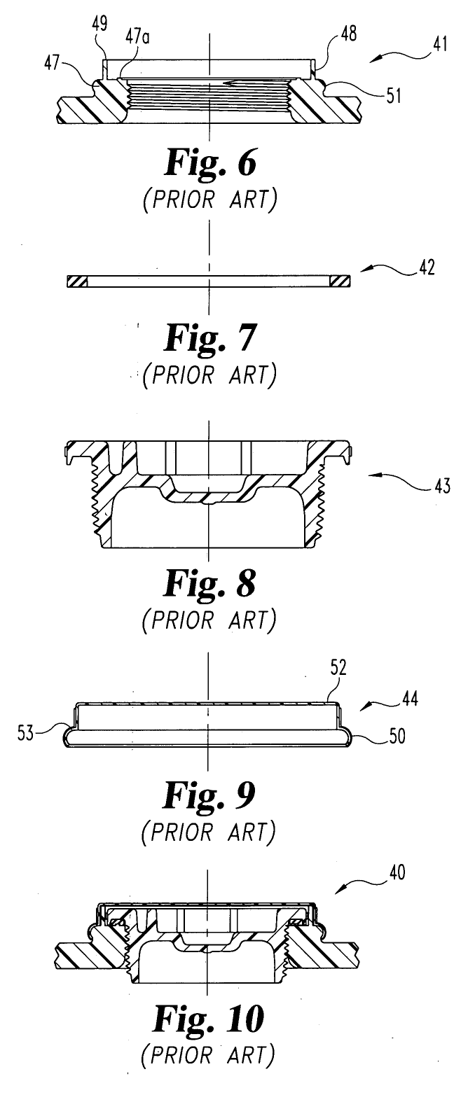

Referring to FIGS. 6-10, another prior art closure system 40 is illustrated. System 40 includes a container opening 41, a gasket 42, plastic plug 43 and tamper-evident cover 44. The assembly of component parts 42-44 into container opening 41 is illustrated in FIG. 10. In this prior art embodiment (system 40) the annular wall 47 that defines internally-threaded opening 41 includes a generally cylindrical wall extension 48. The tamper-evident cover 44 rests on the upper edge 49 of wall extension 48 while lower skirt 50 wraps around annular form 51. Tamper-evident cover 44 includes a plastic body 52 and a surrounding metal shell 53. Shaping or crimping of the metal shell 53 is used so as to conform the plastic to, around and beneath annular form 51. The plastic portion of tamper-evident cover 44 must be defeated in order to have access to the top interior portion of plug 43. System 40 represents another style of prior art closure and container design that is being improved upon by the present invention.

Each cylindrical wall 27 and 47 includes a raised annular rib 27a and 47a, respectively, that is embedded into its corresponding gasket 22 and 42, respectively. Gaskets 22 and 42 are substantially identical to each other in form, fit and function. In this particular application as disclosed for the two prior art systems, gaskets 22 and 42 are square-cut gaskets that fit between the radial flange of the plastic plug and the upper surface of the wall that defines the container neck opening. With regard to the plastic plugs 23 and 43, these two components are substantially identical to each other in form, fit and function.

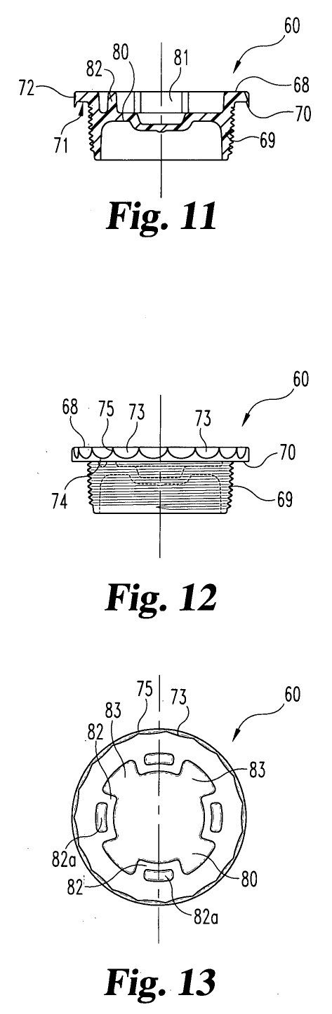

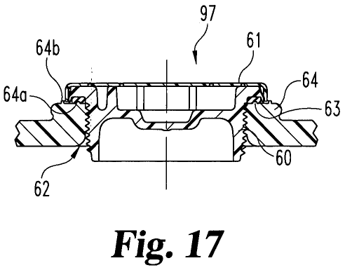

Referring now to FIGS. 11-17, the plastic plug 60 and plastic overcap 61 of a new closure system are illustrated. The cooperating container opening 62 is based primarily on the FIG. 6 construction but without the wall extension 48. The square-cut gasket 63 is substantially the same as gasket 22, or as gasket 42, for example. The wall 64 defining the internally-threaded container opening 62 includes a corresponding raised annular rib 64a. In addition, spaced apart from annular rib 64a is an outer annular rib 64b. As illustrated in FIG. 17, the outer wall portion of overcap 61 fits down in close proximity to the upper surface of the wall 64 in close proximity to annular rib 64b, though radially inside of annular rib 64b.

With continued reference to FIGS. 11-13, the unitary plastic plug 60 is similar to prior art plugs 23 and 43, except for the unique contouring or shaping of radial flange 68. Flange 68 extends radially outwardly from threaded body 69 and terminates in short, depending axial wall 70 that helps to define inverted gasket channel 71. The outer annular surface 72 of flange 68 is shaped or contoured with curved, concave recesses 73 that are closed at the bottom edge 74 with a curved shape as shown in FIG. 12. The raised edge 75 between adjacent pairs of recesses 73 helps to create a driving spline that in cooperation with the overcap 61 facilitates the line-to-line interfit between the overcap 61 and the plug 60 and helps to prevent any relative motion between the overcap 61 and plug 60.

In the exemplary embodiment there are a total of nineteen recesses 73 and thus a corresponding total of nineteen raised spline edges 75. The recesses 73 are arranged in an annular series. This number is believed to be the right balance between concave depth, circumferential width and the number of interfit locations with corresponding projections formed on the overcap 61. The plug 60 includes an interior shelf 80 and the open space 81 above shelf 80 includes radially inwardly-projecting forms 82 and alternating recesses 83. Each form 82 defines a central opening 82a. These interior shapes that are defined above shelf 80 are used for plug tightening and removal after initial opening. As will be described, the overcap 61 is securely attached to the plug 60 (see FIG. 16) prior to initial assembly of this combination into the threaded opening 62. While specialized tooling is used for this installation, once the tamper-evident overcap 61 is opened by tearing out a portion of the upper panel 90, conventional equipment or tooling can be used in cooperation with the plug 60 interior shapes to permit removal of the plug 60 from opening 62 and to permit reclosing of the opening 62 with plug 60. The threaded style for the threaded body 69 of plug 60 is preferably a buttress thread or pipe thread (as shown).

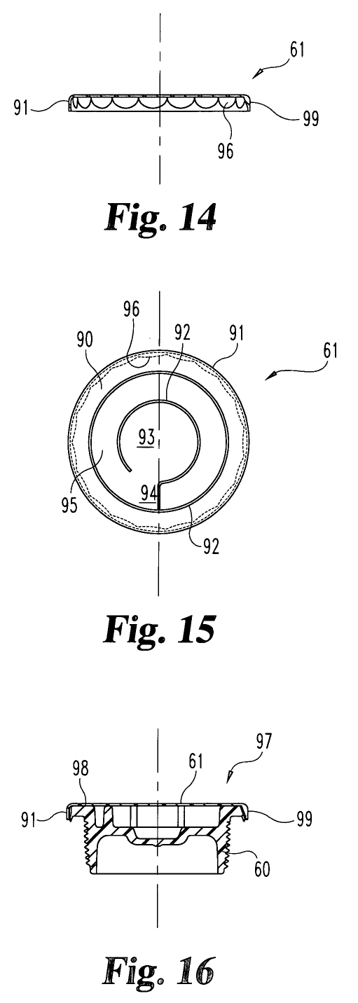

Referring to FIGS. 14-16, the overcap 61 is illustrated in greater detail. Overcap 61 is a relatively thin, unitary plastic member having an upper panel 90 surrounded by a depending annular wall 91. The upper panel 90 defines a weakened score line 92 that creates a circular pull tab 93 that connects at portion 94 to annular ring 95. The weakened score line 92 extends around annular ring 95, and annular ring 95 is a tear-out portion. When overcap 61 is applied to plug 60 (see FIG. 16), the area directly beneath tab 93 is open making it easy to punch tab 93 free and thereafter be in a position for grasping. By grasping tab 93, the ring 95 is able to be separated from the upper panel of the overcap 61. This in turn provides an opening of sufficient size for the tightening and loosening of plug 60 using those interior shapes above shelf 80. These interior shapes include forms 82 and recesses 83.

The annular wall 91 of overcap 61 is shaped or contoured with nineteen radially inwardly extending projections 96. Each projection 96 has a smoothly curved convex geometry and a spacing that closely matches the concave geometry of each recess 73 in plastic plug 60. The projections 96 are arranged in an annular series. These matching shapes on the overcap 61 and plug 60 permit a close line-to-line and precise interfit of overcap 61 onto the top flange portion of plug 60 so that each projection 96 is fitted closely and precisely into a corresponding recess 73.

Although the radial depth of each recess 73 is not particularly significant in terms of its actual dimension, it is significant in the manner that each projection 96 is received. Further, the close fit of the inside diameter of wall 91 relative to and with the outside diameter of surface 72 helps to insure that overcap 61 will not turn or slip around plug 60. While the interfit of projections 96 and recesses 73 is one way of securing the overcap 61 and plug 60 together as an integral unit, the overcap 61 is rigidly and securely connected to plug 60 by ultrasonically welding these two components together. The actual weld locations can be a spot weld location in terms of the ultrasonic welding and a plurality of spot weld locations 98 are preferred. However, only one ultrasonic weld location would be sufficient.

While recesses 73 and projections 96 have a specific curvature and geometry, what is illustrated and described is only one of several options. Functionally, the important characteristic is the interfit between the plug 60 and overcap 61 so as to help prevent relative turning or rotation between these two parts as the plug portion is being threaded into the container opening. The curved recesses 73 and corresponding and cooperating projections 96 can be changed to a different shape and can be annularly arranged in a different number. The male-female relationship can also be reversed.

With the overcap 61 securely fitted onto 60 (assembly 97) and ultrasonically welded into an integral combination, the FIG. 16 assembly 97 is created. Since the outer surface 99 of overcap wall 91 is smooth and generally cylindrical and since the plug shapes for installing and removing plug 60 are covered by overcap 61, another approach for installing the overcap 61 and plug 60 assembly 97 needs to be found, especially since there are no shapes or contours on the exterior of the overcap 61 that might be used for this purpose.

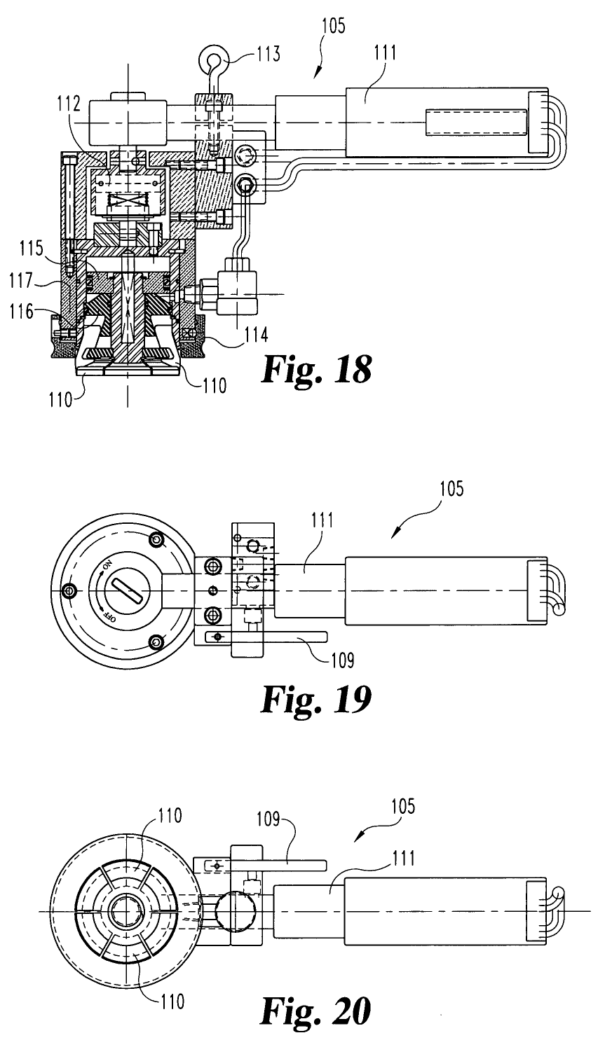

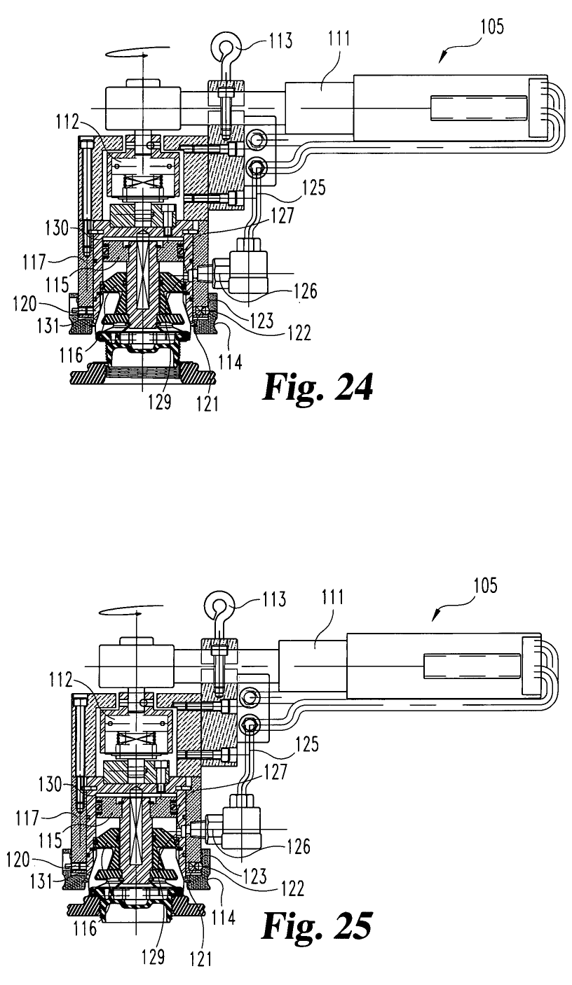

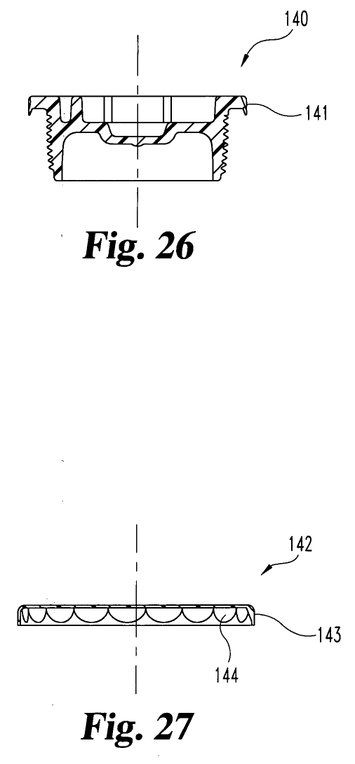

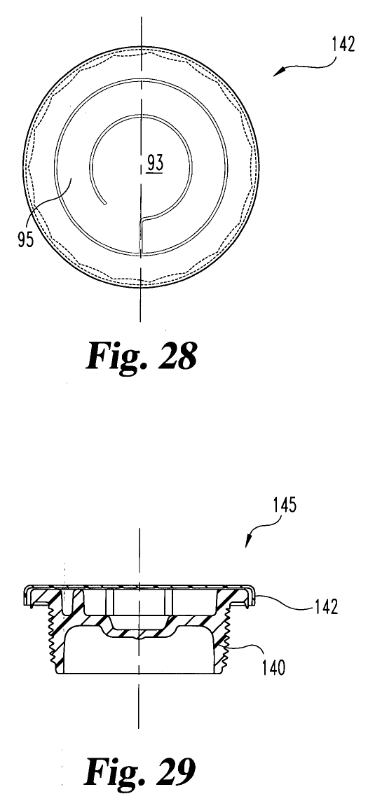

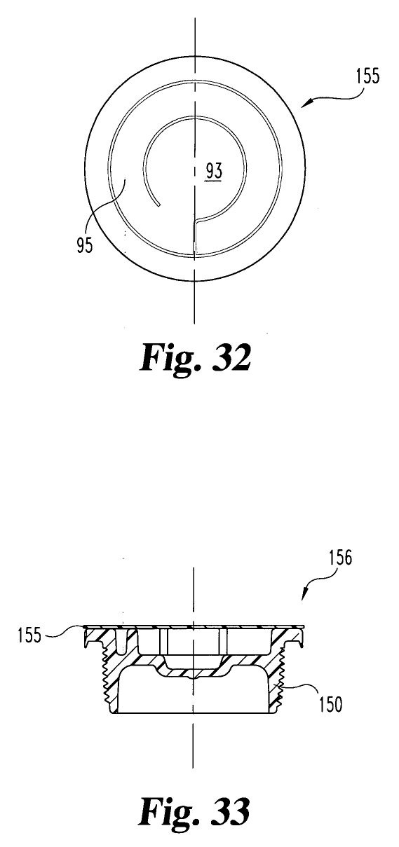

As illustrated in FIGS. 26-33, and as described herein, other plug and overcap combinations are contemplated consistent with the present invention. These other embodiments are presented after the explanation of the tooling (see FIGS. 18-25) since this same tooling is suitable for these other embodiments and since the method of use and method of installing is generally the same for these other embodiments as it is for the plug 60 and overcap 61 assembly 97.

Referring now to FIGS. 18-25, suitable tooling for the installation (and removal) of the overcap 61 and plug 60 assembly 97 is illustrated. In terms of removal, if the center panel of overcap 61 is opened by removal of the tab and ring as described above, the plug 60 forms or shapes that are on the interior and above shelf 80 can be used with a suitable hand tool or wrench that fits those particular shapes. However, the very likely possibility exists that a drum manufacturer may install assembly 97 at the time of shipping the completed drum to the filler. Upon receipt, the filler will need to remove assembly 97 in order to fill the drum and removal of assembly 97 needs to be done without altering or modifying overcap 61. By allowing overcap 61 to remain intact and continue to function as a tamper-evident component it will be necessary to use the described tooling in the manner disclosed. Once the drum is filled, the tooling is used to reinstall assembly 97 to the desired tightening torque and overcap 61 is then able to function as a tamper-evident component up until the time of initial opening by the end user when it is time to dispense the container contents.

Referring now to FIGS. 18-25, the air-actuated tooling fixture 105 associated with assembly 97 (overcap 61 as integrally attached to plug 60) and the method of installing (and removing) is illustrated. The tooling details are illustrated in the partially sectioned view of FIG. 18 beginning in an initial or open condition. FIGS. 19 and 20 are intentionally abbreviated in their details so as to provide more of a diagrammatic illustration, primarily to provide an overview of tooling fixture 105 and to more specifically show the bottom plan orientation of the six gripping collets 110 that are used to grasp the outside diameter of the overcap 61 by placing those collets up against the outer surface of annular wall 91.

In terms of the primary component parts of fixture 105, there is a control lever 109 for valve actuation, an automatic, reversible wench drive 111, a torque-limiting drive assembly 112, a counterbalance eyelet 113, a sliding detent ring 114, a movable piston 115, the six collets 110 and associated components and mounting hardware so as to assemble these primary component parts. Some of these associated components create an outer housing 117 that receives drive assembly 112, piston 115 and at least portions of the six collets 110. It is this outer housing 117 that helps to define the interior chamber 129. Also included as one of the primary component parts of tooling fixture 105 is a holder 116 that is also positioned within the outer housing 117 and cooperates with the six collets 110 so as to control their movement and positioning as will be described. Further, holder 116 is positioned relative to piston 115 such that the introduction of air pressure at their interface causes these two components to separate from one another by the introduction of this air pressure into the interior of the outer housing.

The method of operation and use of tooling fixture 105 begins with the collets 110 in an open or unclamped position as illustrated in FIG. 18. In this arrangement the sliding detent ring 114 is positioned axially above the larger diameter portion of each collet 110. As will be described and as illustrated in FIGS. 18-25, the tooling fixture 105 begins in this open condition prior to movement of the tooling fixture to the point where an assembly 97 can be grasped or alternatively moving an assembly 97 to the location of the tooling fixture 105.

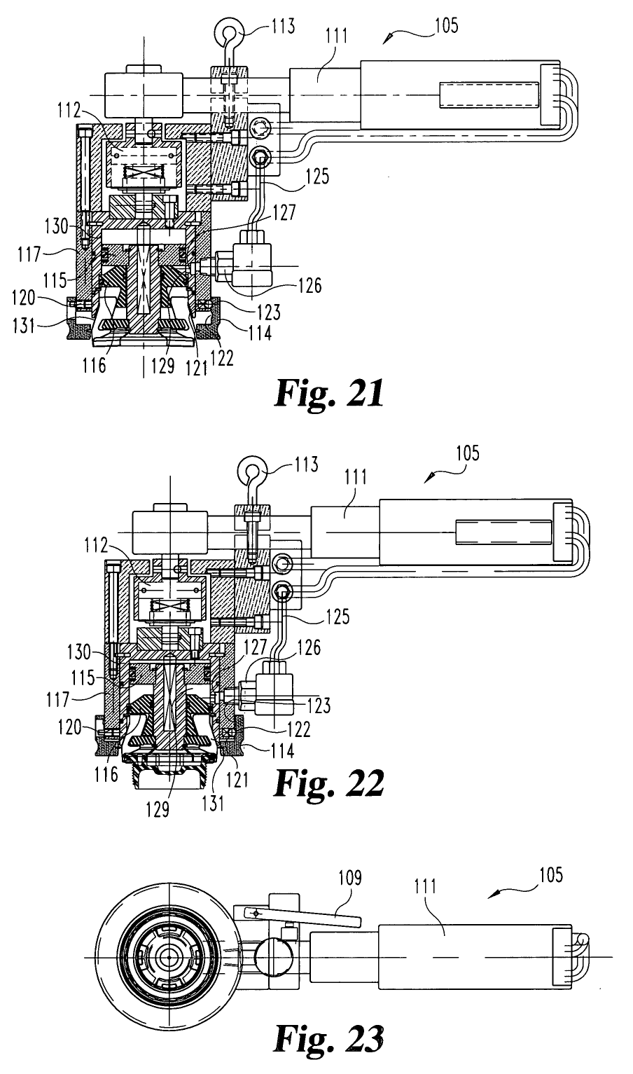

When a plug/overcap assembly 97 is to be installed into a container opening, the sliding detent ring 114 is lowered from the FIG. 18 position to the FIG. 21 position. Pin 120 sets the axial upper and axial lower limits of travel for detent ring 114 and spring-loaded ball 121 provides the “detent” feature as it snaps into the lower ring depression 122 (see FIG. 18) or the upper ring depression 123 (see FIG. 21). Although assembly 97 is not included in the FIG. 21 illustration, this initial movement and positioning of detent ring 114 is intended to partially close the collets 110 in order to be able to loosely hold onto the assembly 97. The FIG. 21 illustration represents the plug-loading step prior to secure gripping and prior to rotation for threaded installation.

Referring now to FIGS. 22 and 23, the next step in the installation procedure is to provide an air line 125 and nozzle 126 with an inlet 127 located between piston 115 and holder 116. As indicated, holder 116 cooperates with the six collets 110 to control their movement and positioning around the outside diameter of assembly 97. Holder 116 also seals off the lower region of chamber 129 so that the air pressure that is introduced through inlet 127 into chamber 129 pushes upwardly on piston 115. This causes the piston 115 to move in an upward direction and that movement raises the collets 110 and causes sleeve 130 to gradually push against the outwardly inclined surfaces 131 of each collet 110. Since sleeve 130 cannot move outwardly, this increasing interference causes the lower edge of each collet to pivot inwardly and thereby securely grasp onto the outside diameter of the assembly 97, specifically onto the outer annular wall 91 of overcap 61 with the plug 60 serving as a structural backup to this gripping by the six collets.

The introduction of air pressure by way of inlet 127 pushes up on piston 115 and draws the ends of the collets 110 inwardly, thereby closing tightly on the assembly 97. The air pressure is set for the desired holding or gripping force based on relative sizes and dimensions and based on the amount of movement permitted with the piston and the angle of incline on each of the collets. The assembly 97 must be and is securely and tightly gripped by the collets 110 before there is any possibility of turning or rotating the assembly 97 for its threaded insertion into the internally-threaded opening 62 of the container. In order to insure that the collets have tightly grasped onto assembly 97 before air is delivered to the wrench drive, an air valve is triggered by the movement of the piston 115. Until the piston moves to the desired position, this valve is not opened so that air can be delivered to the wrench drive 111. However, the piston first moves to a location that causes the collets 110 to tightly grasp onto assembly 97. After the assembly 97 is tightly grasped by the six collets, and only after this occurs is air pressure delivered to wrench drive 111. Accordingly, there is no risk of trying to start rotating or turning assembly 97 for threaded insertion until assembly 97 is properly and securely gripped by the collets.

One possible design variation to this foregoing sequence is to arrange the air flow lines with a sensor that is constructed and arranged to sense a “no-flow” condition after air flow is initiated. The initiated air flow moves the piston 115, as has been described, and when the piston movement reaches its limit, the air flow into chamber 129 stops. The sensor mentioned above is constructed and arranged to recognize that the air flow into chamber 129 has stopped and, at that point, the sensor triggers an opening or open valve condition so that an air flow path is provided to the wrench drive 111. This construction sequences the air flows such that rotation of the collets 110 does not begin until the assembly 97 is firmly and securely grasped by those collets 110.

The drive head 135 has a ratchet design that is reversible and includes a driveshaft 136 that connects to drive assembly 112 and from there, through sleeve 130 and ultimately collets 110. As the plug 60 portion of assembly 97 becomes fully tightened into opening 62, a resistive force level is sensed by the torque-limiting drive assembly 112 (see FIG. 25). At the predetermined and selected tightening torque, the drive assembly 112 alerts the user/installer that the desired torque level has been reached and it is time to release the control lever 109. The release of the control lever releases the air pressure and the air vents to atmosphere allowing the collets 110 to release the plug and overcap assembly 97.

With continued reference to FIGS. 18-25, a further design variation that is contemplated as part of the present invention is to eliminate drive assembly 112. If this change is made, then the maximum air pressure to the wrench drive 111 is set so as to correspond to the desired or target assembly torque of the plug 60 into the container opening 62.

A still further design variation for the illustrated tooling and for the method of use and the method of installing is to generate the air pressure for clamping the collets 110 and for rotation of the collets 110 concurrently, rather than sequentially. This approach avoids the need for any valving or sensing that would otherwise be required for the sequential operation of the air flows. What occurs with this alternate design is to slowly turn or rotate the group of six collets 110 as the piston 115 is lifting upwardly and pulling upwardly on the collets. This rotation of the group of collets continues as the individual collets 110 gradually close onto assembly 97. Once the assembly is grasped or gripped securely by the collets 110, the rotation causes the plug body to be threaded into the container opening 62.

If the plug and overcap assembly 97 is to be removed by the drum manufacturer or by a filler, the same tooling fixture 105 is used in reverse. The grasping procedure is the same using air pressure to clamp the collets 110 around the outside diameter of the assembly 97. Thereafter, the wrench drive 111 is used but now in a reversed direction so as to unthread the assembly 97 from within opening 62.

Referring now to FIGS. 26-29, another plug and cap combination, according to the present invention, is illustrated. Plug 140 is generally the same as plug 60 with a style of recesses 141 that correspond generally to the recesses 73 in form, fit, and function. As already noted, the interfit of the recesses 73 and projections 96 is but one of several possible arrangements. The shaping of each recess 73 and the cooperating shaping of each projection 96 can be changed and the male-female roles reversed.

Overcap 142 is generally the same as overcap 60 in terms of form and function. The difference between overcap 142 and overcap 61 is the inside diameter size of outer wall 143 and similarly the outside diameter size of that wall. However, in terms of the present invention, the focus is on the size of the inside diameter of outer wall 143. This is the wall surface where the projections 144 are formed for interfit with recesses 141. The difference is that with a larger inside diameter, there is a slight clearance or separation between the projections 144 and the recesses 141 at the time of initial assembly of the overcap 142 onto and over the top of plug 140. This assembly 145 is illustrated in FIG. 29. As such, there is no initial interfit between the projections 144 and the recesses 141. Rather, this interfit is only established as the collets 110 close in on the outer wall 143 and push that outer wall inwardly toward plug 140. This inward movement of the outer wall 143 causes the annular series of projections 144 to be brought into engagement and into interfit with the corresponding annular series of recesses 141.

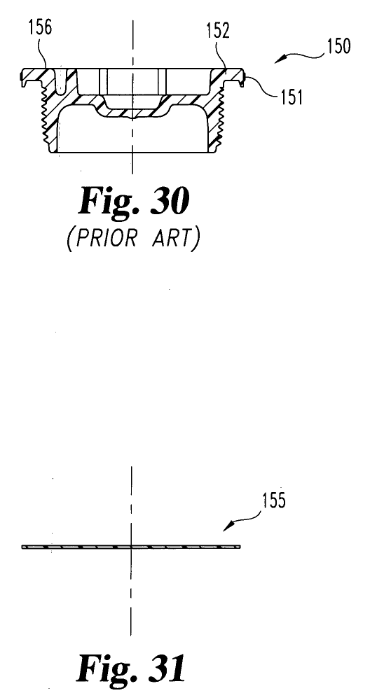

Referring now to FIGS. 30-33, another plug and overcap combination, according to the present invention, is illustrated. Plug 150 is generally the same as plug 23 (prior art) without any recesses or projections of the type illustrated with regard to plug 60 and overcap 61. While the outer wall 151 of radial flange 152 includes small, shallow axial ribs or splines, these are only provided as very minor texturing for this outer surface and do not constitute anything comparable to recesses or projections for an anti-rotation interfit.

Overcap 155 is a substantially flat, relatively thin disk and one species of overcap 155 is a unitary plastic member. In another species of overcap 155, it is a heat-weld foil disk. Overcap 155, regardless of the species style, is constructed and arranged to be securely attached to the top 156 of plug 150. For the plastic species, this attachment is accomplished by ultrasonic welding at one or more spots. For the foil species, this attachment is accomplished by heat welding, similar to typical foil liners.

The overcap 155 has an outside diameter size that generally corresponds to the outside diameter size of radial flange 152. As such, with the overcap 155 centered on the plug at the time of attachment, the outer circular edges of the plug 150 and overcap 155 are generally aligned with each other and are generally concentric. This assembly 156 is illustrated in FIG. 33.

Overcap 155 is illustrated with the punch through center panel 93 and the annular ring portion 95 as previously illustrated with the earlier overcap embodiments. With the foil species, this opening structure can be removed and thus require the user to pierce the foil disk and either manually or with pliers tear the disk off, or at least tear an opening in the disk sufficient to reach the interior forms of the plug for purposes of removing the plug from the container at the time of initial use.

While the preferred embodiment of the invention has been illustrated and described in the drawings and foregoing description, the same is to be considered as illustrative and not restrictive in character, it being understood that all changes and modifications that come within the spirit of the invention are desired to be protected.

1. A closure for a container opening comprising:
a plug including overcap-engaging means and being constructed and arranged to be received within said container opening; and
an overcap including plug-engaging means constructed and arranged for interfit into said overcap-engaging means, said overcap being attached to said plug so as to create an integral assembly, wherein said interfit helps to prevent rotation of said overcap relative to said plug.

2. The closure of claim 1 wherein said plug includes a radially flange and said overcap-engaging means is formed in said radial flange.

3. The closure of claim 2 wherein said overcap-engaging means having a concave shape.

4. The closure of claim 3 wherein said overcap including an outer wall and said plug-engaging means being formed as part of said outer wall.

5. The closure of claim 4 wherein said plug-engaging means having a convex shape.

6. The closure of claim 5 wherein said concave shape and said convex shape have corresponding curvatures for a line-to-line interfit.

7. The closure of claim 1 wherein said plug and said overcap are attached by an ultrasonic weld location.

8. The closure of claim 1 wherein said overcap-engaging means includes a plurality of concave recesses arranged in an annular series.

9. The closure of claim 8 wherein said plug-engaging means includes a plurality of convex projections arranged in an annular series.

10. The closure of claim 1 wherein said overcap includes an upper panel defining a tamper-evident tear-out portion.

11. The closure of claim 10 wherein said tear-out portion being defined by a weakened score line.

12. The closure of claim 1 wherein said overcap includes an outer wall and said plug-engaging means are located around an inner surface of said outer wall.

13. The closure of claim 12 wherein said plug includes an outer wall and said overcap-engaging means are located around an outer surface of said outer wall.

14. A method of installing a plug and overcap assembly into a container opening using an air-actuated tooling fixture, said tooling fixture including moveable collets, a reversible wrench drive, a sliding detent ring, a piston and a holder, said method comprising the following steps:
(a) positioning the collets around the assembly;
(b) moving the sliding detent ring to begin a partial hold of said assembly in position over said opening;
(c) activating a supply of air to introduce air pressure into a chamber within said tooling fixture;
(d) raising a piston in response to said air pressure in said chamber;
(e) moving said collets in response to raising said piston for clamping said collets onto said assembly;
(f) supplying air to said wrench drive for applying a turning torque to said assembly; and
(g) installing said assembly into said container opening.

15. The method of claim 14 wherein said raising step includes the step of opening a valve for supplying air to said wrench drive.

16. The method of claim 15 wherein the tooling fixture includes a torque-limiting drive assembly and which further includes the step of sensing an installing torque via the torque-limiting drive assembly.

17. The method of claim 16 which further includes the step of releasing the air pressure when a predetermined torque is reached.

18. A tooling fixture for use in installing a closure into a container opening, said tooling fixture comprising:
an air-operated wrench drive;
a moveable piston positioned within a housing;
a plurality of gripping collets moveable with said piston;
an air valve constructed and arranged to provide a supply of air into said housing;
a sleeve connected to said drive assembly and constructed and arranged to apply pressure to said collets; and
whereby operation of said wrench drive results in rotation of said collets.

19. The tooling fixture of claim 18 wherein said air-operated wrench drive is reversible.

20. The tooling fixture of claim 19 wherein movement of said piston activates said air valve for supplying air to said wrench drive.

21. The tooling fixture of claim 20 which further includes a torque-limiting drive assembly is constructed and arranged to sense a torque level from said collet rotation.

22. The tooling fixture of claim 21 wherein said torque-limiting drive assembly is constructed and arranged to release air pressure from said valve at a predetermined torque level.

23. In combination:
a container defining a container opening; and
a closure constructed and arranged to be received by said container opening, said closure comprising:
a plug having an upper surface and interior forms for use in turning said plug; and
a tamper-evident overcap constructed and arranged to be securely attached to said upper surface so as to close off said interior forms, wherein a tamper-evident capability is created without reliance on any tamper-evident interfit between said closure and said container.

24. In combination:
a container defining a container opening; and
a closure constructed and arranged to be received by said container opening, said closure comprising:
a plug including overcap-engaging means and being constructed and arranged to be received within said container opening; and
an overcap including plug-engaging means constructed and arranged for interfit into said overcap-engaging means, said overcap being attached to said plug so as to create an integral assembly, wherein said interfit helps to prevent rotation of said overcap relative to said plug.

25. The combination of claim 24 wherein said overcap includes an upper panel defining a tamper-evident tear-out portion, wherein a tamper-evident capability is created without reliance on any tamper-evident interfit between said closure and said container.
